(19) United States
(12) Patent Application Publication
(10) Pub. No.: US 2014/0205774 A1
(43) Pub. Date: Jul. 24, 2014

(54) GLAZING UNIT WITH PERIPHERAL SEAL AND CORRESPONDING MANUFACTURING PROCESS

(71) Applicants: Sebastien Caliaro, Jumet (BE); Francois Closset, Jumet (BE); Priscille Dreux, Jumet (BE); Olivier Fontaine De Ghelin, Jumet (BE)

(72) Inventors: Sebastien Caliaro, Jumet (BE); Francois Closset, Jumet (BE); Priscille Dreux, Jumet (BE); Olivier Fontaine De Ghelin, Jumet (BE)

(73) Assignee: AGC Glass Europe, Louvain-la-Neuve (BE)

(21) Appl. No.: 14/235,973

(22) PCT Filed: Jun. 27, 2012
(86) PCT No.: PCT/EP2012/062498

§ 371 Date: Jan. 29, 2014

(30) Foreign Application Priority Data
Aug. 3, 2011 (BE) BE 2011/0479

(51) Int. Cl. E06B 3/663; E06B 3/66

(52) U.S. Cl. CPC E06B 3/66342; E06B 3/6612
USPC 428/34; 29/428

(57) ABSTRACT

The invention relates to a glazing unit, in particular an insulating glazing unit, comprising at least a first (5) and a second (5) glass sheet joined together via at least one spacer (8) that keeps them a certain distance apart from each other and, between said at least two glass sheets, at least one internal space (4) closed by a peripheral seal (101) placed on the periphery of the glass sheets, around said internal space, the seal having a U-shaped cross section comprising a first flange (ion) securely fastened to the first glass sheet and a second flange (1012) securely fastened to the second glass sheet. According to the invention, the first flange is securely fastened in a first recess (521) produced in the edge face of the first glass sheet.

### FIELD OF THE INVENTION

The field of the invention is that of glazing units comprising glass sheets delimiting internal spaces also referred to as multiple glazing units.

More specifically, the invention relates to the peripheral seals of these multiple glazing units.

These units can be used in any kind of application such as multi-purpose glazing units, glazing units for vehicles or for buildings.

### SOLUTION OF THE PRIOR ART

A glazing unit in accordance with the invention is an insulating glass unit, for example.

Such an insulating glass unit classically comprises a first and a second glass sheet joined together by means of at least one spacer or interlayer, which holds them parallel at a certain distance from one another. The unit is tightly closed on its periphery by means of a peripheral seal so that the space between the glass sheets, also called the internal space, is completely closed.

The internal space can enclose a cushion of gas, for example, but not exclusively dry air, argon (Ar), krypton (Kr), xenon (Xc), sulphur hexafluoride (SF₆) or even a mixture of some of these gases. The transfer of energy through an insulating unit with this classic structure is reduced compared to a single glass sheet because of the presence of the cushion of gas in the internal space.

The internal space can also be drained of any gas, this then being referred to as vacuum glazing. The energy transfer through a vacuum insulation glass unit is greatly reduced by the vacuum space.

A vacuum glass unit is typically composed of at least two glass sheets separated by a space, in which a vacuum has been created. Such a glazing unit is classically used for its high thermal insulation properties. The thickness of the vacuum space is typically 80 μm to 80 μm. In order to achieve high insulation performance rates, the pressure inside the glazing unit is generally in the order of 10-3 mbar or even less. To obtain such a pressure inside the glazing unit, a seal is placed on the periphery of the two glass sheet and the vacuum is created inside the glazing unit by means of a pump. To prevent the glazing unit from collapsing under atmospheric pressure (because of the pressure difference between the inside and the outside of the glazing unit), spacers are placed at regular intervals (in the form of a matrix, for example) between the two glass units. In general, at least one of the two glass sheets is coated with a low-emissivity layer with an emissivity ideally of less than 0.05.

The spacers are generally cylindrical or spherical and are referred to as pillars. Nowadays, these spacers are generally made of metal and therefore create heat losses in the glazing unit. To maintain a heat transfer coefficient U of less than 0.6 W/m²K, the total surface of the spacers in contact with the glass must represent less than 1% of the surface of the vacuum glass unit.

Different seal technologies exist and each has certain disadvantages.

A first type of seal (the most widespread) is a seal based on a soldering glass with a melting temperature lower than that of the glass of the glass panels of the glazing unit. The use of this type of seal limits the choice of low-emissivity layers to those that are not impaired by the thermal cycle necessary for usage of the soldering glass, i.e. to that which can withstand a temperature that can be as much as 350° C. Moreover, since this type of seal based on soldering glass has very little deformability, it does not enable the effects of differential expansions between the glass panel of the glazing on the internal side and the glass panel of the glazing on the external side to be absorbed, when these are subjected to large differences in temperature (40° C., for example). Quite significant stresses are then generated at the periphery of the glazing unit and can cause breakages of the glass panels of the glazing unit.

A second type of seal comprises a metal seal, e.g. a metal strip of low thickness (<500 μm) soldered around the periphery of the glazing unit by means of a bonding sub-layer covered at least partially by a layer of a tin alloy soft solder-type solderable material. A significant advantage of this second type of seal compared to the first type of seal is that it can be deformed to absorb the differential expansions created between the two glass panels. There are different types of sub-layers for bonding onto the glass panel.

U.S. Pat. No. 5,227,206 discloses a first embodiment of a peripheral seal of the second type for vacuum glazing. According to this embodiment, the seal is a metal strip with a cross-section substantially in the shape of a U, the two parallel arms of which are joined to one another by means of a base that can be curved or straight. The two arms sandwich the two glass sheets between them.

However, as part of this embodiment the final shaping of the strip in a U must be achieved around the two glass panels. In fact, it is not possible to place the two glass sheets as well as the spacers on a frame with a U-shaped cross-section that is already closed. Therefore, it is not possible to separate the step of production and insertion of the sealing strip in the panel from that of assembling the glass sheets of the glazing unit (which involves longer assembly times and higher costs).

Moreover, the metal strip forms a thermal bridge on the periphery of the glazing unit between the exterior and the interior of the glazing unit. This results in deterioration of the overall insulation performance of the glazing unit.

Moreover, in contrast to a “classic” multiple glazing unit filled with gas or dry air, with this solution the sealing strip is not protected by the two glass sheets and this results in a risk of perforation or tearing of the seal that can cause leakages and can interfere with the installation of the glazing in its frame.

EP patent No. 2099997 B1 discloses a second embodiment of a peripheral seal of the second type for vacuum glazing. According to this embodiment, the seal also has a cross-section substantially in the shape of a U, in which the two parallel arms are joined to one another by means of a base that can be curved or straight. The two arms sandwich the two glass sheets between them.

Besides the aforementioned disadvantages, as part of this second embodiment it is necessary to implement an additional step of joining the two strips.

### OBJECTS OF THE INVENTION

An object of the invention in particular is to remedy these disadvantages of the prior art.

More precisely, an object of the invention in at least one of its embodiments is to provide a technique that enables a glazing unit comprising at least two glass sheets delimiting at least one internal space to be sealed by means of a peripheral seal.

Another object of the invention in at least one of its embodiments is to provide such a technique that enables the peripheral seal to be placed after the (or at least some of the) glass sheets of the glass unit have been assembled.

Another object of the invention in at least one of its embodiments is to provide such a glazing unit with improved thermal insulation performance.

Another object of the invention in at least one of its embodiments is to provide such a technique that enables the peripheral seal to be protected.

Another object of the invention in at least one of its embodiments is to provide such a technique that enables the glazing unit to be mounted on a classic frame for multiple glazing.

Another object of the invention in at least one of its embodiments is to provide such a technique that is easy to configure.

A further object of the invention in at least one of its embodiments is to provide such a technique that is inexpensive.

### OUTLINE OF THE INVENTION

In accordance with a particular embodiment, the invention relates to a glazing unit, in particular an insulating glass unit, comprising at least one first and one second glass sheet joined together by means of at least one spacer, which holds them at a certain distance from one another, and between these at least two glass sheets at least one internal space closed by a peripheral seal arranged on the periphery of the glass sheets around said internal space, wherein the seal has a cross-section in the shape of a U having a first arm fixed to the first glass sheet and a second arm fixed to the second glass sheet.

According to the invention, the first arm is fixed in a first recess formed in the edge of the first glass sheet.

The roles of the first and second glass sheets are, of course, interchangeable.

Glass is, of course, understood to mean all types of glasses and equivalent transparent materials such as mineral glasses and organic glasses. Mineral glass can be equally formed from one or more types of glasses known as soda-lime glasses, boron glasses, crystalline and semi-crystalline glasses. Organic glass can be a transparent thermoset or rigid thermoplastic polymer or copolymer such as a polycarbonate synthesis resin, transparent polyester or polyvinyl, for example.

The general principle of the invention rests on the formation of at least one recess in the edge of the glass sheets to receive one of the arms of the peripheral seal, which is U-shaped in cross-section.

Thus, the technique of fixing the peripheral seal to the panel according to the invention provides increased protection for the peripheral seal and in particular the sensitive part of the peripheral seal. In fact, the seal is less exposed than in the state of the art solutions. Moreover, the seal can be protected by a bead of polymer (silicone, PU . . . ) in the same way as classic multiple glazing units.

Furthermore, this technique of fixing the seal enables improved thermal insulation performance rates to be achieved in particular because of the reduction of losses due to the edge effect.

Moreover, this fixing technique enables the peripheral seal to be placed after assembling the glass sheets of the unit because the seal can be inserted afterwards in the recess(es) provided in the edge(s) of the glass sheet(s).

Advantageously, the second arm is fixed in a second recess formed in the edge of the second glass sheet.

According to an advantageous feature of the invention a vacuum of less than 1 mbar prevails in the internal space.

Hence, the glazing unit is a vacuum glazing unit.

Advantageously, the spacers are arranged between the first and the second glass sheet in order to form a matrix with a pitch in the range of between 20 mm and 80 mm and preferably in the range of between 30 and 60 mm.

Advantageously, the glazing unit additionally comprises a thermal insulation layer arranged on the inside surface of at least one of the glass sheets.

Thus, the overall thermal insulation obtained because of the glazing unit is further increased.

According to an advantageous feature of the invention, at least one of the first and the second recesses opens to the face to the outside of the unit of the glass sheet in which it is formed.

The face to the outside of the unit of a glass sheet is understood to mean the face that is not associated with the internal space. Similarly, face to the inside of the unit of a glass sheet is understood to mean the other face (that which is not? associated with the internal space).

Advantageously, the peripheral seal is a metal seal.

According to an advantageous feature of the invention, the peripheral seal is a metal strip.

Advantageously, at least one arm of the seal is fixed to the corresponding glass sheet by soldering at least one portion of the arm to an adhesion layer provided on the portion of the glass sheet that receives the portion of the arm.

The invention also relates to a process for manufacturing a glazing unit, in particular an insulating glass unit, comprising the following steps:
joining together at least one first and one second glass sheet by means of at least one spacer that holds them at a certain distance from one another;
closing at least one internal space between said at least two glass sheets by a peripheral seal arranged on the periphery of the glass sheets around said internal space, wherein the seal has a U-shaped cross-section comprising a first arm fixed to the first glass sheet and a second arm fixed to the second glass sheet.

According to the invention the process also comprises the following steps:
forming a first recess in the edge of the first glass sheet;
fixing the first arm in the first recess formed in the edge of the first glass sheet.

### LIST OF FIGURES

Other features and advantages of the invention will become clearer upon reading the following description of a preferred embodiment given by way of non-restrictive example and the attached drawings, wherein:

FIG. 1 is a diagram of a vacuum glazing unit according to an embodiment of the invention;

FIGS. 2a, 2b and 2c shows first and second peripheral seals fixed to the recesses and? formed in the glass sheets of the unit of FIG. 1 according to first and second embodiments of the invention;

FIG. 3 illustrates a process for manufacturing a glazing unit according to an embodiment of the invention.

### DESCRIPTION OF AN EMBODIMENT OF THE INVENTION

The present invention will be described with reference to particular embodiments and with reference to certain drawings, but the invention is not limited by this and is only limited by the claims. The size and relative dimensions of certain elements may be exaggerated in the drawings and may not be drawn to scale for illustrative reasons.

Moreover, the terms first, second, third and the like in the description and in the claims are used to distinguish between similar elements and not necessarily to describe a sequence, whether in time, space or for purposes of classification or other purposes. It should be understood that the terms thus used are interchangeable in appropriate circumstances and that the embodiments of the invention described here can function in other sequences than those described or illustrated here.

Moreover, the terms high, low, above, below and the like in the description and the claims are used for descriptive reasons and not necessarily to describe relative positions. It should be understood that the terms thus used are interchangeable in appropriate circumstances and that the embodiments of the invention described here can function in other sequences than those described or illustrated here.

It should be noted that the term “comprising” used in the claims should not be interpreted as being restricted to the elements listed thereafter and does not exclude other elements or steps. It should therefore be interpreted as specifying the presence of the specified elements, entities, steps or components referred to, but does not exclude the presence or addition of an element, entity, step or component, or group thereof. Therefore, the scope of the expression “a device comprising elements A and B” should not be limited to devices only consisting of components A and B. This means that as far as the present invention is concerned the only relevant components of the device are A and B.

As used here and unless indicated otherwise, “seal” is understood to mean seal against any gas that could be used in a double glazing unit to improve insulation (e.g. argon) or seal against air or any other gas present in the atmosphere (in the case of a vacuum glazing unit).

As used here and unless indicated otherwise, “thermal insulation layer” is understood to mean a metal oxide layer that has an emissivity of less than 0.2, preferably less than 0.1 and more preferred less than 0.05. A thermal insulation layer can be one of the following layers, for example: Planibel G, Planibel Top N, Top N+ and Top 1.0 supplied by AGC.

As used here and unless indicated otherwise, the term “spacer” relates to one or more elements that assure a relatively constant distance between two adjacent glazing units.

The following description will relate to the particular case of a glazing unit according to the invention that is a vacuum glazing unit. Naturally, the invention also relates to any type of glazing unit comprising glass sheets (two, three or more) delimiting internal spaces (also referred to as multiple glazing units) that are insulating or not.

For example, the invention also applies to a double glazing unit where the internal space can enclose a cushion of gas, for example, but not exclusively dry air, argon (Ar), krypton (Kr), xenon (Xe), sulphur hexafluoride (SF₆) or even a mixture of some of these gases.

For example, the invention also applies to a triple glazing unit comprising a first internal space, in which a vacuum is created, and a second internal space comprising a cushion of insulating gas(es).

Naturally, other variants are conceivable, in particular replacing one of the glass sheets of the unit with a laminated glass sheet or by any other addition or modification.

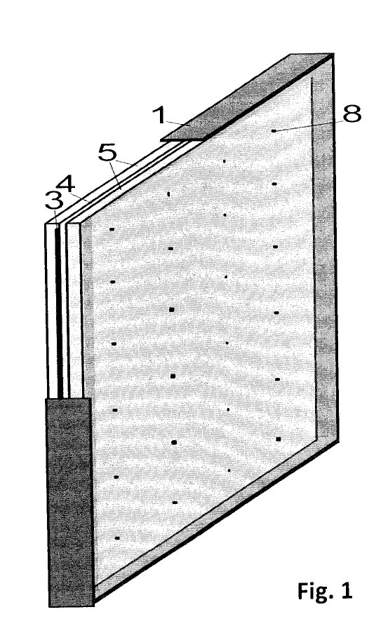

With respect to FIG. 1, this shows an overall view of a vacuum glazing unit according to an embodiment of the invention.

The vacuum glazing unit comprises first and second glass sheets 5 (6 mm thick sheets of clear soda-lime-silica glass, for example) joined together by means of at least one spacer 8, which holds them at a certain distance from one another. Hence, the first and second glass sheets 5 are separated by a first internal space 4 that forms a first cavity, in which a vacuum of less than 1 mbar prevails, e.g. equal to 10⁻³ mbar (obtained by pumping into the cavity by means of a vacuum pump).

Any type of glass and thickness of glass can, of course, be used.

The vacuum glazing unit also comprises a plurality of spacers 8 according to the invention, wherein the spacers are sandwiched between the first and second glass sheets 5 in order to maintain the first space between these glass sheets 5.

For example, the spacers are arranged between the first and second glass sheets in order to form a matrix with a pitch in the range of between 20 and 80 mm and preferably in the range of between 30 and 60 mm.

The spacers 8 can be of different shapes such as cylindrical, spherical, hourglass-shaped, cross-shaped . . .

The following description relates to an example according to the invention, in which the spacers 8 are made from AISI301 steel and configured in the shape of a C.

The step of shaping the austenitic steel firstly comprises a step of obtaining a wire with a cylindrical cross-section by wire drawing. The step of obtaining the wire can, of course, also be achieved by hot extrusion of said AISI301 steel, then wire drawing to obtain the final diameter of the wire.

For example, working from a wire of 5 mm in diameter on which the wire drawing operation is conducted, a refined wire with a diameter of 1 mm is obtained (which represents an 80% reduction in cross-section of the wire).

The step of shaping the austenitic steel then comprises a cutting step (e.g. by means of wire cutters) of at least one portion of the wire to form said spacer. The length of said portion of wire is 4 mm, for example.

According to an advantageous embodiment the step of shaping the austenitic steel then comprises a step of bending said portion of wire over at least one of its portions in order to shape a loop portion with a maximum radius of curvature of 0.5 mm.

The bending step can, of course, be conducted before the cutting step.

The portion of wire is preferably a segment of a circle with a radius of curvature of 0.5 mm.

Hence, in this second example the step of cold working is combined with the wire drawing step.

Thus, during the wire drawing operation an 80% reduction in cross-section of the wire causes an increase in the strength of the AISI stainless steel from 620 MPa to about 1400 MPa.

For example, if AISI spacers that are not cold worked (that therefore have a compressive strength of 620 MPa) are used, which have a contact surface equivalent to a disc with a radius of 250 μm, a spacing of 30 mm between these, a vacuum glazing unit having a U coefficient value equal to 0.8 W/(m²K) is obtained.

Conversely, using the aforementioned spacers according to the invention (made of cold-worked AISI 301 in a C shape), which have a compressive strength of 1400 MPa, it is possible to reduce the number of spacers by spacing them 50 mm apart while improving the U value, which becomes about 0.5 W/(m²K).

The U values of vacuum glazing units are estimated on the basis of a glazing described above including a low-emissivity type layer. The heat transmissions (U values) have been evaluated using the method described in the publication of the University of Sydney: Determination of the Overall Heat Transmission Coefficient (U-Value) of Vacuum Glazing, T M Simko, A H Elmandy and R E Collins, Ashrae Transactions, 105, pt. 2, pp 1-9, 1999.

In order to further improve performance rates in terms of thermal insulation, a thermal insulation layer can be arranged on an inside surface of at least one of the glass sheets 5.

The two glass sheets 5 are assembled in a gastight manner (assuring the vacuum) by means of a peripheral seal 1 placed on the periphery of the glass sheets 5 around the internal space 4 tightly closing the first cavity.

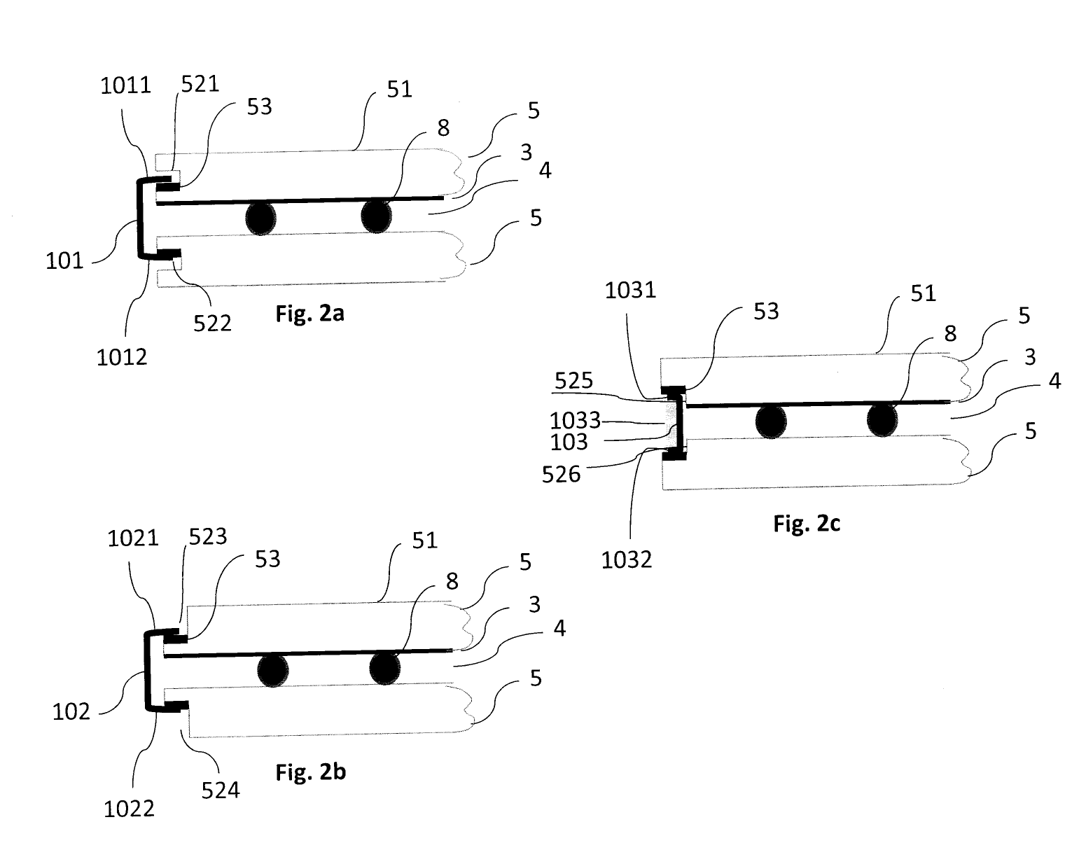

With respect to FIGS. 2a, 2b and 2c, these show first 101, second 102 and third 103 peripheral seals fixed to the recesses 521, 522 and 523, 524 and 525, 526 formed in the glass sheets 5 of the glazing unit of FIG. 1 according to the first and second embodiments of the invention.

Only portions of the section of the glazing are shown in FIGS. 2a, 2b and 2c.

The first seal 101 has a U-shaped cross-section comprising a first arm 1011 fixed in a first recess 521 formed in the edge of the first glass sheet and a second arm 1012 fixed in a second recess 522 formed in the edge of the second glass sheet.

The second seal 102 has a U-shaped cross-section comprising a first arm 1021 fixed in a third recess 523 formed in the edge of the first glass sheet and a second arm 1022 fixed in a fourth recess 524 formed in the edge of the second glass sheet.

The third seal 103 has a U-shaped cross-section comprising a first arm 1031 fixed in a fifth recess 525 formed in the edge of the first glass sheet and a second arm 1032 fixed in a sixth recess 526 formed in the edge of the second glass sheet. In addition, the seal can be protected by a bead 1033 of polymer such as silicone, PU, . . . in the same manner as in classic multiple glazing units.

The first 521 and second 522 recesses do not open to one of the faces of the first and second glass sheet.

The third 523 and fourth 524 recesses open to the outside face 51 of the first and second glass sheet respectively.

The fifth 525 and sixth 526 recesses open to the inside face of the first and second glass sheet respectively.

The first 101, second 102 and third 103 peripheral seals are metal strips, for example, that each have a U-shaped cross-section and each comprise first and second arms.

The first 1011; 1021; 1031 and second 1012; 1022; 1032 arms of the first 101, second 102 and third 103 seals are fixed to the first and second glass sheets 5 respectively by soldering (e.g. performed by means of a tin solder joint) a portion of these arms onto portions of adhesion layers 53 provided in the corresponding recesses 521, 522, 523, 524, 525, 526.

For example, the adhesive material forming the adhesion layers 53 can be selected from the group consisting of copper and its alloys (e.g. with titanium and/or chromium), aluminium and its alloys, iron and its alloys (such as Fe-Ni austenitic steels: e.g. iron (50-55% by weight, e.g. 52% by weight), nickel (45-50% by weight, e.g. 48% by weight) such as alloy 48), the iron alloys comprising the following metals: iron (53-55% by weight, e.g. 53.5% by weight), nickel (28-30% by weight, e.g. 29% by weight) and cobalt (16-18% by weight, e.g. 17% by weight), and Kovar®, platinum and its alloys, nickel and its alloys, gold and its alloys, silver and its alloys, gallium arsenide and tin and its alloys. This list is not exhaustive.

The seal can, of course, be formed in any other manner, e.g. by means of two metal strips soldered in the recesses of the glass sheets and also soldered to one another. Moreover, any other technique can be used for fixing the seal to the recess(es) without departing from the framework of the invention, e.g. soldering directly onto the glass using soldering glass (no adhesion layer 53 is necessary in this case) or by fitting together by force.

According to variants of the abovementioned embodiment that are not illustrated, the glazing unit can, of course, also comprise a third glass sheet separated from any one of the first and second glass sheets (e.g. from the second glass sheet) by a second space in order to form a second cavity.

According to a first variant, a second seal is additionally placed on the periphery of the third and second glass sheets in order to maintain the second space (e.g. with a thickness of 16 mm), wherein said second cavity is filled with at least one gas. The gas can, for example, be air, argon, nitrogen, krypton, xenon, SF₆, CO₂ or any other thermal insulation gas.

According to a second variant, the third and second glass sheets are assembled in a gastight manner (assuring the vacuum) by means of a seal placed on the periphery of the glass sheets tightly closing the second cavity and a plurality of spacers according to the invention are sandwiched between the third and second glass sheets in order to maintain the second space between these glass sheets. A triple vacuum glazing unit is thus obtained.

Other variants are, of course, conceivable in particular replacing a glass sheet with a laminated glass panel or by any other addition or modification.

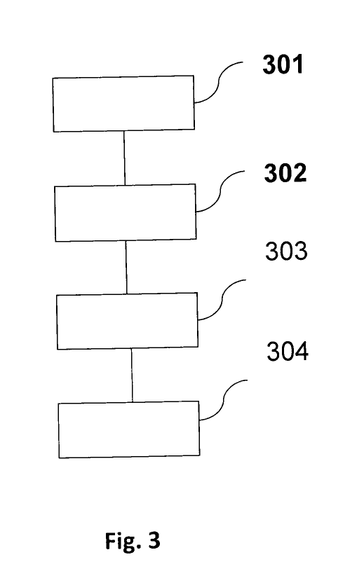

With respect to FIG. 3, this shows a process for manufacturing the vacuum glazing unit of FIG. 1 according to an embodiment of the invention.

The manufacturing process comprises the following steps:
joining 301 together the first and second glass sheets 5 by means of spacers 8 that hold them at a certain distance from one another;
closing 302 the internal space 4 between the two glass sheets 5 by the peripheral seal 1, 101; 102, 103 arranged on the periphery of the glass sheets around the internal space.

According to the invention the process also comprises the following steps:
forming 303 recesses 521, 522; 523, 524; 525, 526 in the edge of the glass sheets 5; and
fixing 304 the arms 1011, 1012; 1021, 1022; 1031, 1032 in the recesses 521, 522; 523, 524; 525, 526.

The invention is, of course, not limited to the aforementioned exemplary embodiments.

1. A glazing unit, comprising a first glass sheet and a second glass sheet joined together by a spacer, which holds the glass sheets at a certain distance from one another, and between the two glass sheets, at an internal space closed by a peripheral seal arranged on a periphery of the glass sheets around the internal space,
wherein the seal has a cross-section in a shape of a U having a first arm fixed to the first glass sheet and a second arm fixed to the second glass sheet, and
the first arm is fixed in a first recess formed in an edge of the first glass sheet.

2. The glazing unit according to claim 1, wherein the second arm is fixed in a second recess formed in an edge of the second glass sheet.

3. The glazing unit according to claims 1, wherein a vacuum of less than 1 mbar prevails in the internal space.

4. The glazing unit according to claim 3, wherein the spacer is arranged between the first and the second glass sheet in order to form a matrix with a pitch in the range of between 20 mm and 80 mm.

5. The glazing unit according to claim 1, further comprising a thermal insulation layer arranged on an inside surface of at least one of the glass sheets.

6. The glazing unit according to claim 1, wherein at least one of the first and the second recesses opens to a face to an outside of a unit of the glass sheet in which it is formed.

7. The glazing unit according to claim 1, wherein the peripheral seal is a metal seal.

8. The glazing unit according to claim 1, wherein the peripheral seal is a metal strip.

9. The glazing unit according to claim 7, wherein an arm of the seal is fixed to a corresponding glass sheet by soldering a portion of the arm to an adhesion layer on a portion of the glass sheet that receives the portion of the arm.

10. A process for manufacturing a glazing unit, comprising:
joining together a first glass sheet and a second glass sheet with a spacer that holds the glass sheets at a certain distance from one another; and
closing an internal space between said the two glass sheets by a peripheral seal arranged on a periphery of the glass sheets around the internal space, wherein the seal has a U-shaped cross-section comprising a first arm fixed to the first glass sheet and a second arm fixed to the second glass sheet
wherein the process also comprises:
forming a first recess in an edge of the first glass sheet; and
fixing a first arm in the first recess formed in the edge of the first glass sheet.

11. The glazing unit according to claim 3, wherein the spacer is arranged between the first and the second glass sheet in order to form a matrix with a pitch in the range of between 30 mm and 60 mm.

12. The glazing unit according to claim 1, wherein the glazing unit is an insulating glass unit.

13. The method according to claim 10, wherein the glazing unit is an insulating glass unit.
